(19) United States
(12) Patent Application Publication
(10) Pub. No.: US 2025/0158766 A1
(43) Pub. Date: May 15, 2025

(54) TERMINAL, BASE STATION, AND COMMUNICATION METHOD

(71) Applicant: NTT DOCOMO, INC., Tokyo (JP)

(72) Inventors: Yuki Takahashi, Chiyoda-ku, Tokyo (JP); Satoshi Nagata, Chiyoda-ku, Tokyo (JP); Yu Jiang, Haidian District, Beijing (CN); Jing Wang, Haidian District, Beijing (CN); Ru Feng, Haidian District, Beijing (CN); Anxin Li, Haidian District, Beijing (CN)

(73) Assignee: NTT DOCOMO, INC., Tokyo (JP)

(21) Appl. No.: 18/838,530

(22) PCT Filed: Feb. 18, 2022
(86) PCT No.: PCT/JP2022/006766

§ 371 Date: Aug. 14, 2024

(51) Int. Cl. H04L 5/00; H04W 24/10; H04W 52/02

(52) U.S. Cl. CPC H04L 5/0048; H04W 24/10; H04W 52/0209

(57) ABSTRACT

A terminal includes: a receiving unit configured to receive a reference signal on a downlink; and a transmitting unit configured to transmit a result of measurement based on the reference signal on an uplink. The receiving unit is further configured to receive information indicating antenna ports of a base station that are supported by the reference signal.

### FIELD OF THE INVENTION

The present invention relates to a terminal, a base station, and a communication method in a wireless communication system.

### BACKGROUND OF THE INVENTION

The requirements of “New Radio” (NR) (also referred to as “5G”), which is a successor system of long-term evolution (LTE), include large system capacity, high data transmission speed, low latency, simultaneous access from multiple terminals, low cost, power saving, and so forth, and a variety of technologies are under study to meet these requirements (see, for example, non-patent document 1).

In NR Release 18, an energy consumption model for base stations is under study. The details are a topic for future study.

### RELATED-ART DOCUMENTS

### Non-Patent Documents

Non-Patent Document 1: 3GPP TS 38.300 V16.6.0 (2021 June)

### SUMMARY OF THE INVENTION

### Technical Problem

In order to achieve carbon neutrality and SDGs (Sustainable Development Goals), it is becoming increasingly important to save the power consumption of base stations. However, the problem is that there are no standardized techniques for saving base stations' power consumption.

The present invention has been made in view of the foregoing, and aims to save the power consumption of base stations.

### Solution to Problem

According to the techniques disclosed herein, a terminal is provided. This terminal includes: a receiving unit configured to receive a reference signal on a downlink; and a transmitting unit configured to transmit a result of measurement based on the reference signal on an uplink. The receiving unit is further configured to receive information indicating antenna ports of a base station that are supported by the reference signal.

### Advantageous Effects of Invention

According to the techniques disclosed herein, techniques are provided whereby the power consumption of base stations can be saved.

### BRIEF DESCRIPTION OF THE DRAWINGS

FIG. 1 is a diagram for explaining a wireless communication system according to an embodiment of the present invention;

FIG. 2 is a diagram for explaining CSI-RS port indication;

FIG. 3 is a diagram for explaining the types of CSI-RS resources and CSI reporting;

FIG. 4 is a diagram showing an example basic operation of CSI-RS-based measurement;

FIG. 5 is a diagram showing examples of showing a CSI-RS port information elements configuration according to an option 1-2 of an example 1 of an embodiment of the present invention;

FIG. 6 is a diagram for explaining port indication in periodic CSI reporting according to example 1 of an embodiment of the present invention;

FIG. 7 is a diagram for explaining port indication in periodic CSI reporting according to example 1 of an embodiment of the present invention;

FIG. 8 is a diagram showing examples of information elements showing the setting of periodic CSI group listing according to an option 2-1 of an example 2 of an embodiment of the present invention;

FIG. 9 is a diagram for explaining a periodic CSI group list according to option 2-1 of example 2 of an embodiment of the present invention;

FIG. 10 is a diagram for explaining TRX switching according to example 2 of an embodiment of the present invention;

FIG. 11 is a diagram showing an example functional structure of a base station according to an embodiment of the present invention;

FIG. 12 is a diagram showing an example functional structure of a terminal according to an embodiment of the present invention;

FIG. 13 is a diagram showing an example hardware structure of a base station or a terminal according to an embodiment of the present invention; and

FIG. 14 is a diagram showing an example structure of a vehicle according to an embodiment of the present invention.

### DETAILED DESCRIPTION OF THE PREFERRED EMBODIMENTS

Now, embodiments of the present invention will be described below with reference to the accompanying drawings. Note that the embodiments described below are only examples, and the applicability of the present invention is by no means limited to the following embodiments.

Existing techniques used may be as appropriate to operate the wireless communication system according to the embodiments of the present invention. Examples of these existing techniques include, but are not limited to, existing NR or LTE. Also, unless otherwise specified, the term “LTE” as used herein has a broad meaning including LTE-Advanced and systems that emerged after LTE-Advanced (for example, NR).

Also, in the description of following embodiments of the present invention, terms that are used in existing LTE will be used, including synchronization signal (SS), primary SS (PSS), secondary SS (SSS), physical broadcast channel (PBCH), channel (PRACH), physical random access downlink control channel (PDCCH), physical downlink shared channel (PDSCH), physical uplink control channel (PUCCH), physical uplink shared channel (PUSCH), and so forth. This is for ease of description, and signals, functions, and so forth that are substantially the same as these may be referred to by other names. Also, in NR, the above terms correspond to NR-SS, NR-PSS, NR-SSS, NR-PBCH, NR-PRACH, and so forth. However, signals used in NR may not be always written with the prefix “NR-.”

Also, according to the embodiments of the present invention, the duplex method may be time division duplex (TDD), frequency division duplex (FDD), or may be any other method (including, for example, flexible duplex).

Also, according to the embodiments of the present invention, when a radio parameter or the like is “configured,” this may mean that a predetermined value is configured in advance (“pre-configured”), or mean that a radio parameter or the like that is reported from a base station or a terminal is configured.

### (System Structure)

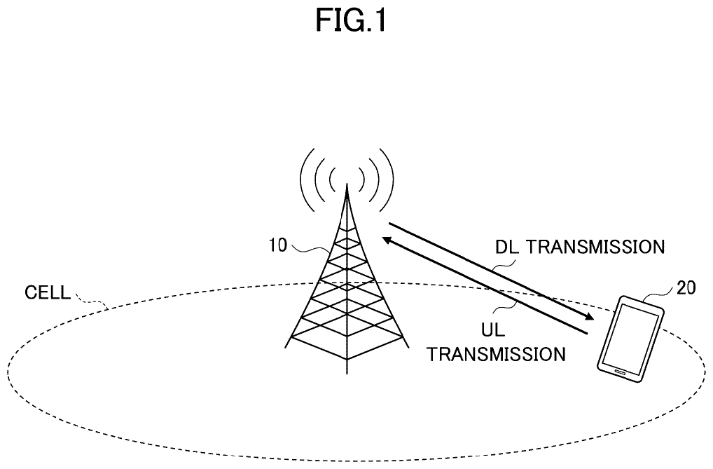

FIG. 1 is a diagram for explaining a wireless communication system according to an embodiment of the present invention. The wireless communication system according to an embodiment of the present invention includes a base station 10 and a terminal 20, as shown in FIG. 1. Although one base station 10 and one terminal 20 are shown in FIG. 1, this is just an example, and there may be two or more of each.

The base station 10 is a communication device that provides one or more cells and performs wireless communication with the terminal 20. The physical resources of radio signals are given in the time domain and the frequency domain. Time domain resources may be indicated by the number of orthogonal frequency division multiplexing (OFDM) symbols, and frequency domain resources may be indicated by the number of subcarriers or resource blocks. Also, a transmission time interval (TTI) in the time domain may be a slot, or a TTI may be a subframe.

The base station 10 transmits synchronization signals and system information to the terminal 20. The synchronization signals include, for example, NR-PSS and NR-SSS. The system information is transmitted, for example, on NR-PBCH, and is also referred to as “broadcast information.” The synchronization signals and system information may be referred to as an “SS/PBCH block” (SSB). Referring to FIG. 1, the base station 10 transmits a control signal or data to the terminal 20 via downlink (DL), and receives a control signal or data from the terminal 20 via uplink (UL). Both the base station 10 and the terminal 20 can transmit and receive signals by using beamforming. Also, both the base station 10 and the terminal 20 can multiple-output (MIMO) apply multiple-input communication to DL or UL. Also, the base station 10 and the terminal 20 may both communicate via a secondary cell (SCell) and a primary cell (PCell) in carrier aggregation (CA). Furthermore, the terminal 20 may communicate via a primary cell of the base station 10 and a primary secondary cell group cell (PSCell: Primary SCG Cell) of another base station 10 in dual connectivity (DC).

The terminal 20 is a communication device with a wireless communication function, such as a smartphone, a mobile phone, a tablet, a wearable terminal, or a machine-to-machine (M2M) communication module. As shown in FIG. 1, the terminal 20 receives control signals or data from the base station 10 via DL, and transmits control signals or data to the base station 10 via UL, thereby using various communication services provided by the wireless communication system. Also, the terminal 20 receives various reference signals transmitted from the base station 10 and measures the quality of propagation paths based on the result of receiving these reference signals. Note that the terminal 20 may be referred to as a “UE,” and the base station 10 may be referred to as a “gNB.”

Next, the trend of discussion on the power saving of base stations in NR Release 18 will be described. Techniques for improving the network energy saving performance of base stations and terminals are under study taking into account both transmission and reception at base stations. For example, methods are being studied that allow a base station to achieve more efficient, dynamic and/or semi-static operations, and achieve finer granularity adaptation of transmission and reception, in one or more network energy saving techniques in time, frequency, spatial, and power domains, by using potential support/feedback from a terminal and using potential assistance information.

Envisaging network energy saving, the following embodiments of the present invention will describe enhancement of channel state information (CSI) measurement and reporting during dynamic on/off control of antennas/TRXs in the spatial domain. Accordingly, existing CSI measurements and the channel state information reference signal (CSI-RS) used in the measurements will be described first.

A terminal is configured with the following information for measurement and reporting:
Reporting setting (CSI-ReportConfig): This indicates how the terminal performs reporting.
Resource setting (CSI-ResourceConfig): This indicates the CSI-RS/SSB resource sets used in CSI/L1-RSRP measurement.

The number of CSI-RS ports in CSI reporting is explicitly indicated in “NZP-CSI-RS-Resource” and “CodebookConfig” in the reporting setting (CSI-ReportConfig).

NR already supports terminals' measurements and reporting under a variety of assumptions in terms of the number of CSI-RS ports.

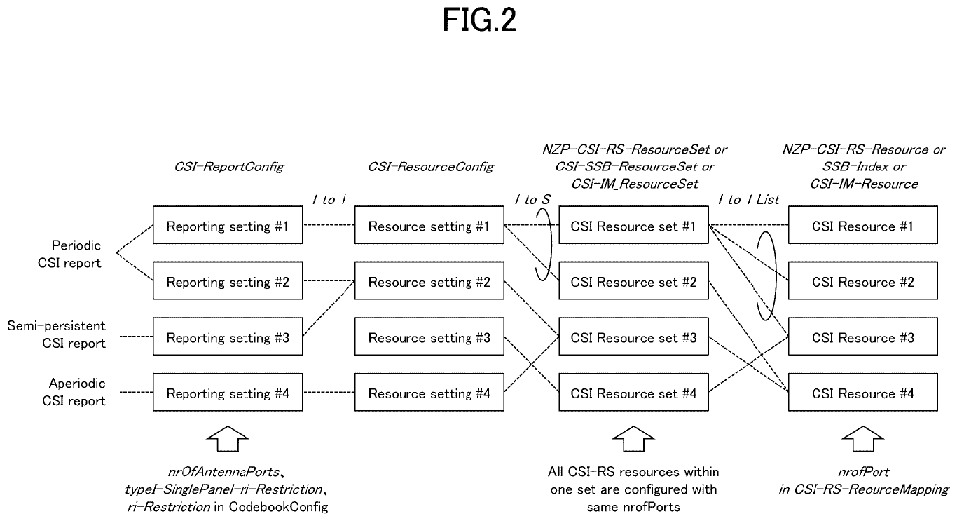

FIG. 2 is a diagram for explaining CSI-RS port indication. For example, by associating different CSI-RS resources (CSI-ResourceConfig) with different reporting settings (CSI-ReportConfig), one terminal can be configured to report CSIs for both the 2-port CSI-RS and the 4-port CSI-RS.

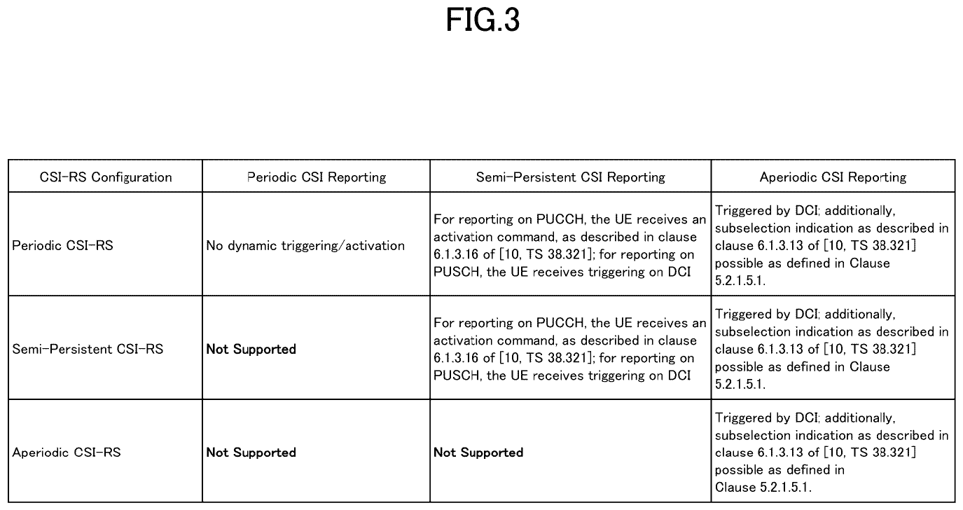

FIG. 3 is a diagram for explaining the types of CSI-RS resources and CSI reporting. A terminal can perform periodic CSI reporting on PUCCH based on periodic CSI-RS resources. A terminal can perform semi-persistent CSI reporting on PUCCH or PUSCH based on periodic CSI-RS resources and semi-persistent CSI-RS resources. Furthermore, a terminal can perform aperiodic CSI reporting on PUSCH based on periodic CSI-RS resources, semi-persistent CSI-RS resources, and aperiodic CSI-RS resources.

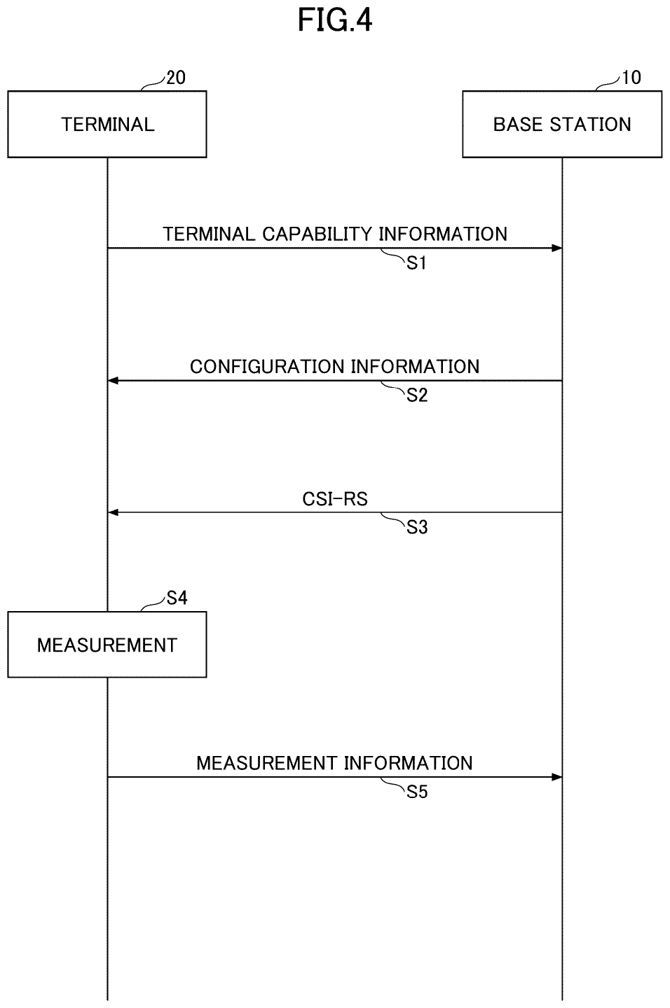

FIG. 4 is a diagram showing an example basic operation of CSI-RS-based measurement. In step S1, a terminal 20 transmits terminal capability information (or “UE capability”) to a base station 10. This terminal capability information is, for example, the terminal capability information that will be later described in example 1 or example 2.

In step S2, the base station 10 transmits configuration information to the terminal 20. This configuration information is, for example, information that indicates the settings related to measurement.

In step S3, the base station 10 transmits a channel state information reference signal (CSI-RS) to the terminal 20.

In step S4, the terminal 20 performs measurement based on the channel state information reference signal. Then, in step S5, the terminal 20 transmits measurement information that shows measurement results, to the base station 10.

### (Existing Problem)

Although support for dynamic/semi-static on/off control of antennas/TRXs has been provided heretofore, the problem is that there is no standardized method of reporting changes in the number of the base station's CSI-RS ports and accompanying changes in reporting settings, to the terminal.

### SUMMARY OF EMBODIMENTS

In the following embodiments, therefore, examples of reporting changes in the number of a base station's CSI-RS ports and accompanying changes in reporting settings to a terminal will be described. Below, an example 1 and an example 2 will be described as specific examples.

### Example 1

In this embodiment, an example will be described in which information about the antenna ports that the CSI-RS supports is reported from a base station 10 to a terminal 20, and in which only CSIs that match the number of CSI-RS ports are reported from the terminal 20.

For CSI reporting, the base station 10 may indicate explicit or implicit information (hereinafter referred to as “port information”) that identifies the antenna ports that the CSI-RS supports.

### <Option 1-1>

The port information may be any of the following alternatives.

### <Alternative 1>

The port information may be the number of CSI-RS ports. For example, in any of the following alternatives, the number of ports may be determined such that all or part of the allowed antenna ports of the CSI-RS are selected.

### <Alternative 1-1>

The number of ports may indicate only the maximum number among the numbers of CSI-RS antenna ports supported.

### <Alternative 1-2>

For the number of ports, a combination of numbers of CSI-RS antenna ports supported may be presented. For example, if the terminal 20 is configured to report CSIs for a 2-port CSI-RS, a 4-port CSI-RS, and an 8-port CSI-RS, and the number of supported ports decreases to 4, the port information to be indicated may include {2, 4}, which is a combination of number of CSI-RS antenna ports supported.

### <Alternative 2>

The port information may be a valid codebook configuration. A valid codebook configuration may refer to, for example, “CodebookConfig(s)” to match the number of CSI-RS ports supported.

### <Alternative 3>

The port information may be a valid CSI-RS resource set. A valid CSI-RS resource set may refer to, for example, “NZP-CSI-RS-ResourceSetId(s)” for channel measurement using a number of CSI-RS ports being supported.

### <Alternative 4>

The port information may be a valid CSI-RS reporting setting. A valid CSI-RS reporting setting may refer to, for example, “CSI-ReportConfigId” to match the number of CSI-RS ports supported.

### <Option 1-2>

The port information may be indicated using any of the following methods.

### <Alternative 1>

Candidate states of port information may be RRC-configured in the terminal 20, and/or a selected state may be indicated via MAC-CE and/or DCI.

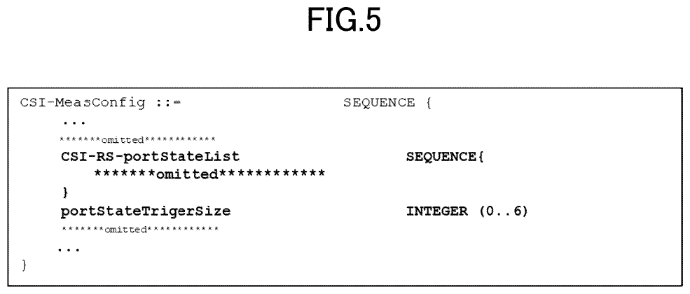

FIG. 5 is a diagram showing examples of information elements that indicate the CSI-RS port configuration according to option 1-2 of example 1 of an embodiment of the present invention. For example, “CSI-RS-portStateList” may be included in “CSI-MeasConfig” as a new RRC information element.

### <Alternative 2>

The port information may be indicated to the terminal 20 by using MAC-CE alone.

### <Alternative 3>

The port information may be indicated to the terminal 20 by using DCI alone.

When DCI is used to indicate the above port information, the port information may be indicated as one of the values according to the following alternatives.

### <Alternative 1>

The port information may be multiplexed with an existing DCI bit field in an existing DCI format. For example, the port information may be multiplexed over a “CSI request” bit field.

### <Alternative 1-1>

An existing field for port indication may be re-interpreted. For example, a new RNTI or another field's value may be used such that existing DCI whether the original meaning is represented or port indication is represented can be identified. For example, the existing DCI field here may be the “CSI request” bit field. Also, in the event the DCI format is one scrambled with an existing RNTI, the value of the field may be interpreted as a CSI request. Furthermore, in the event a DCI format that is scrambled with a new RNTI is used, the value of the field may be interpreted as a port indication.

### <Alternative 1-2>

An existing field may be expanded so as to span a greater number of bits and transmit the port information with the original meaning of the field. For example, the “CSI request” field may be expanded to N bits. The first N1 bits in the “CSI request” field may be used for port indication, and the last N2 bits may be used for a CSI request. N=N1+N2 holds in this case.

### <Alternative 2>

The port information may be a new DCI bit field in an existing DCI format.

### <Alternative 3>

The port information may be a new DCI format with a new RNTI defined for port indication.

In the event above alternative 2 and alternative 3 are employed, the DCI bit size may be indicated using an RRC parameter. For example, as shown in FIG. 5, “portStateTrigerSize” may be included in “CSI-MeasConfig” as a new RRC information element.

### <Option 1-3>

Referring back to option 1-1 or option 1-2 above, port indication may be used in any of the following alternatives.

### <Alternative 1>

Port indication may be used only in periodic CSI reporting, semi-persistent CSI reporting, or aperiodic CSI reporting.

### <Alternative 2>

Port indication may be used in periodic CSI reporting, semi-persistent CSI reporting, and aperiodic CSI reporting.

### <Alternative 3>

Port indication may be used in both periodic CSI reporting and semi-persistent CSI reporting.

### <Alternative 4>

Port indication may be used in both semi-persistent CSI reporting and aperiodic CSI reporting.

### <Alternative 5>

Port indication may be used in both periodic CSI reporting and aperiodic CSI reporting.

### <Option 1-4>

After receiving the port indication according to option 1-1 and option 1-2 in each of the following cases, the terminal 20 may operate as described below.

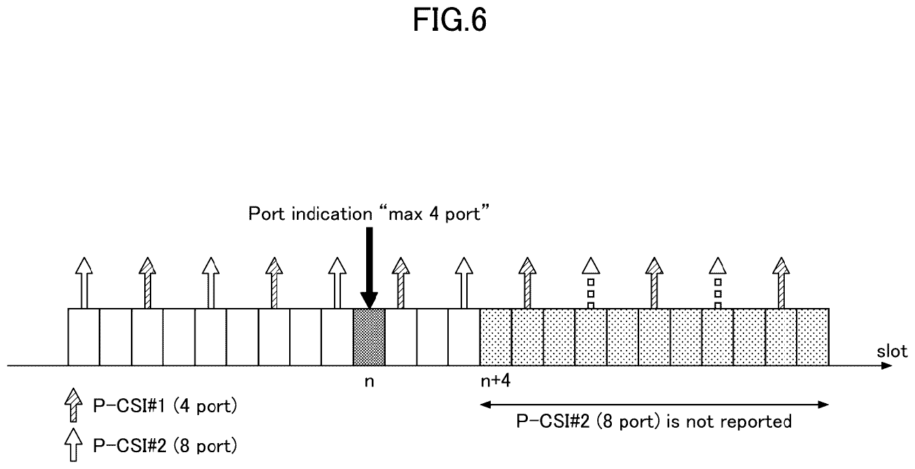

FIG. 6 is a diagram for explaining the port indication in periodic CSI reporting according to example 1 of an embodiment of the present invention.

In the event periodic CSI reporting is employed, the terminal 20 receives the port indication according to option 1-1 and option 1-2. Subsequently, if a CSI report obtained by measuring a CSI-RS corresponding to an unsupported number of ports according to the most recent port indication in a slot (n) is received, the terminal 20 makes the reporting setting invalid from slot (n+X1) on.

Also, in the event periodic CSI reporting is employed, the terminal 20 receives the port indication according to option 1-1 and option 1-2. Subsequently, if a CSI report obtained by measuring a CSI-RS corresponding to the number of ports supported according to the slot (n) is received, the terminal 20 makes the reporting setting valid from slot (n+X2) on.

X1 and X2 may be the same or different. When the reporting setting is made invalid, the terminal 20 does not CSI. On the other hand, if the reporting setting is valid, the terminal 20 reports CSI.

In the event semi-persistent CSI reporting is employed, the terminal 20 receives the port indication according to option 1-1 and option 1-2. Subsequently, if the CSI-RS ports for already-activated semi-persistent CSI reporting are not supported according to the port indication in slot (n), the terminal 20 deactivates the reporting in slot (n+X3).

In the event semi-persistent CSI reporting is employed, the terminal 20 receives the port indication according to option 1-1 and option 1-2. Subsequently, if the CSI-RS ports for already-activated semi-persistent CSI reporting are not supported according to the port indication in slot (n), the terminal 20 recognizes that semi-persistent CSI reporting is not activated.

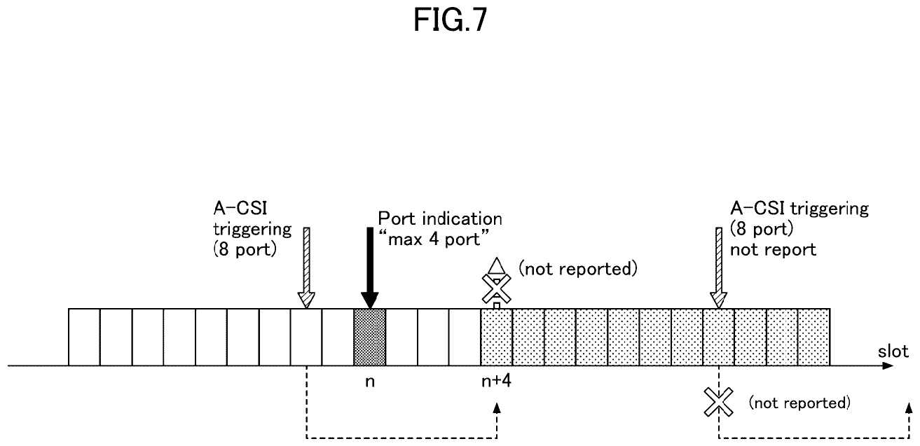

FIG. 7 is a diagram for explaining the port indication in aperiodic CSI reporting according to example 1 of an embodiment of the present invention.

In the event aperiodic CSI reporting is employed, the terminal 20 receives the port indication according to option 1-1 and option 1-2. Then, if the already-triggered aperiodic CSI CSI-RS ports in reporting is not supported according to the port indication in slot (n), the terminal 20 does not report aperiodic CSI after a slot (n+X4).

On the other hand, in the event aperiodic CSI reporting is employed, the terminal 20 receives the port indication according to option 1-1 and option 1-2. Then, if the CSI-RS port in newly triggered aperiodic CSI reporting is not supported according to the most recent port indication, the terminal 20 does not report aperiodic CSI.

The values of X1, X2, X3, or X4 may be set taking into account the terminal capability or the port indication (via DCI or MAC-CE).

According to the present embodiment, the base station 10 reports information about the antenna ports supported by the CSI-RS, to the terminal 20, and the terminal 20 reports only CSIs that match the number of CSI-RS ports. Therefore, it is possible to appropriately limit the antenna ports to be supported by the base station 10 in CSI-RS-based measurements, thereby achieving a reduction in power consumption.

### Example 2

In the event semi-persistent aperiodic CSI reporting is employed, existing activation/deactivation/triggering mechanisms already support the terminal's selection of settings suitable for reporting. However, in the event periodic CSI reporting is employed, new signaling for indication and its settings become necessary.

Therefore, this embodiment will illustrate an example of defining periodic CSI reporting groups. The base station 10 may semi-statistically or dynamically indicate, to the terminal 20, periodic CSI reporting groups that are selected for the terminal's reporting.

### <Option 2-1>

A list of periodic CSI groups may be set forth in RRC.

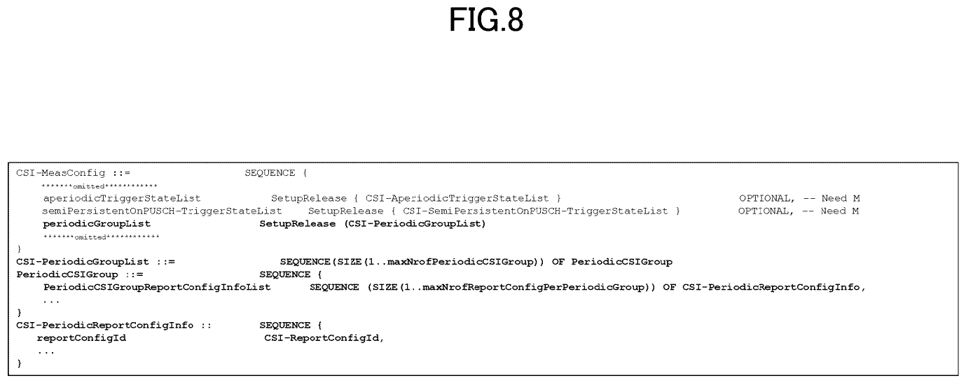

FIG. 8 is a diagram showing examples of information elements indicating the settings of a periodic CSI group listing according to an option 2-1 of example 2 of an embodiment of the present invention. The list of periodic CSI groups may be defined as “CSI-PeriodicGroupList” in “CSI-MeasConfig”.

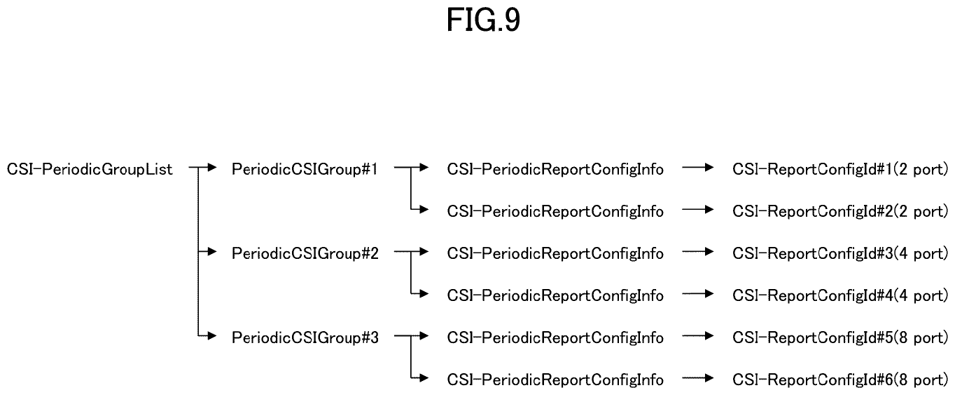

FIG. 9 is a diagram for explaining the listing of periodic CSI groups according to option 2-1 of example 2 of an embodiment of the present invention. “PeriodicCSIGroup” may be included once or multiple times in the list “CSI-PeriodicGroupList”. Also, in each “PeriodicCSIGroup”, “CSI-ReportConfig” may be included once or multiple times. That is, the periodic CSI groups may include port information.

### <Option 2-2>

The base station 10 may indicate a periodic CSI group's index selected for the terminal's reporting, to the terminal 20, using any of the following alternative methods. The terminal 20 identifies the selected periodic CSI group based on the reported index, and performs periodic CSI reporting using a reference signal suitable for the number of ports corresponding to the identified CSI group.

### <Alternative 1>

The base station 10 may indicate the selected periodic CSI group's index to the terminal 20 via MAC-CE.

### <Alternative 2>

The base station 10 may indicate the selected periodic CSI group's index to the terminal 20 via DCI.

### <Alternative 3>

The base station 10 may indicate the selected periodic CSI group's index to the terminal 20 via MAC-CE and DCI.

When DCI is used to indicate the selected periodic CSI group's index, the information to be reported (hereinafter referred to as “CSI group information”) may be indicated according to any of the following alternatives.

### <Alternative 1>

The CSI group information may be multiplexed with an existing DCI bit field in an existing DCI format. For example, the CSI group information may be multiplexed with a “CSI request” bit field.

### <Alternative 2>

The CSI group information may be a new DCI bit field in an existing DCI format.

### <Alternative 3>

The CSI group information may be given in a new DCI format with a new RNTI defined to indicate the index of the periodic CSI group.

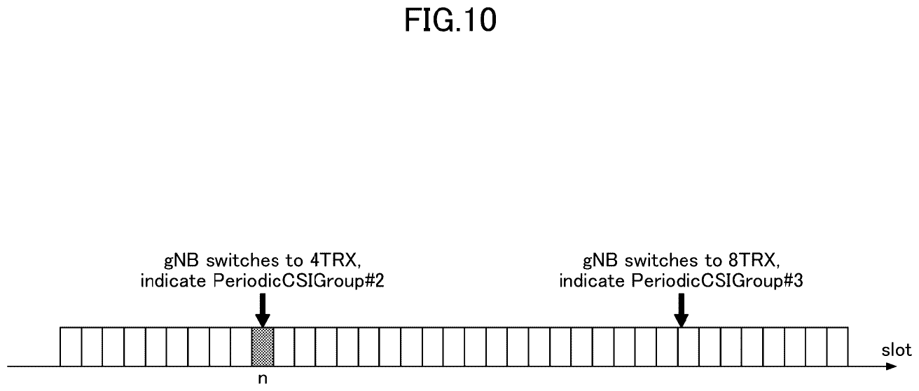

FIG. 10 is a diagram for explaining TRX switching according to example 2 of an embodiment of the present invention. FIG. 10 shows an example in which “PeriodicCSIGroup #2” corresponds to a 4-TRX CSI group, and “PeriodicCSIGroup #3” corresponds to an 8-TRX CSI group, as shown in FIG. 9.

In this case, in order to switch to the 4-TRX CSI group, the base station 10 may indicate “PeriodicCSIGroup #2” to the terminal 20, in slot (n), as the index of the periodic CSI group. Also, in order to switch to the 8-TRX CSI group, the base station 10 may indicate “PeriodicCSIGroup #3” to the terminal 20, in a given slot, as the index of the periodic CSI group.

According to the present embodiment, the base station 10 indicates a periodic CSI reporting group to the terminal 20. By this means, in periodic CSI reporting, it is possible to appropriately limit the antenna ports to be supported by the base station 10, thereby achieving a reduction in power consumption.

In the embodiments described above, “CSI-RS” may be interpreted as “SSB” or other reference signals in initial access (for example, a positioning reference signal (PRS)).

The following capability information may be introduced.

Base station capability information to indicate the capabilities of the base station 10 may be introduced. That is, the base station 10 may transmit the base station capability information to the terminal 20 or another network node. The terminal 20 or another network node having received the base station capability information may assume the capabilities of the base station 10 based on the base station capability information received.

The base station capability information may include information indicating whether or not CSI-RS port information indication is supported.

Also, the following terminal capability information may be introduced. For example, terminal capability information to indicate whether or not a function to receive a CSI-RS port information indication from the base station 10 is supported may be introduced.

### (Device Structure)

Next, example functional structures of the base station 10 and the terminal 20 for performing the processes and operations described above will be described. The base station 10 and the terminal 20 include functions for executing the embodiments described above. However, the base stations 10 and the terminal 20 may each include only part of the functions proposed in the above embodiments.

### <Base Station 10>

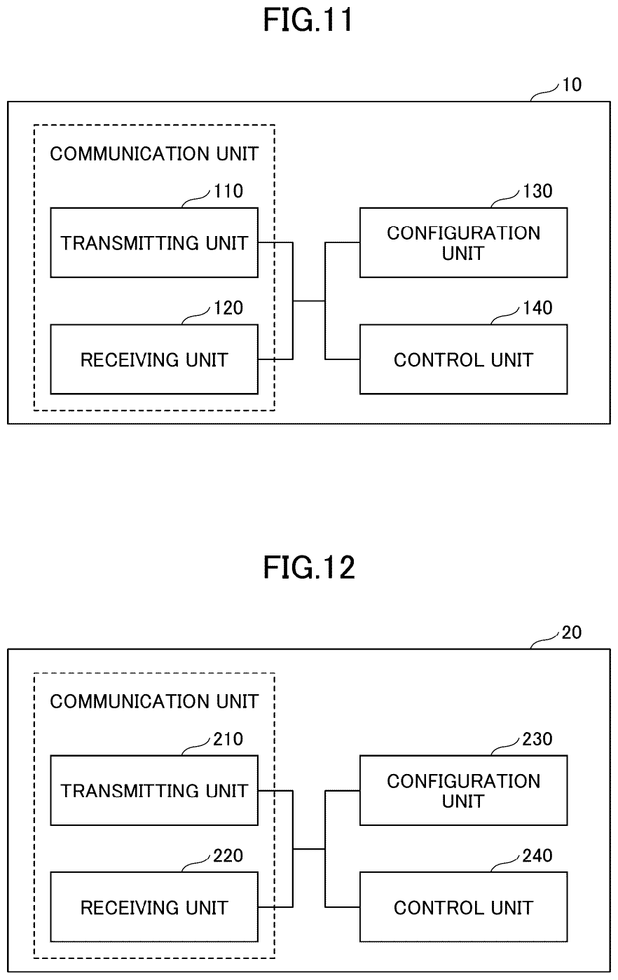

FIG. 11 is a diagram that illustrates an example functional structure of the base station 10. As illustrated in FIG. 11, the base station 10 includes a transmitting unit a receiving unit a 110, 120, configuration unit 130, and a control unit 140. The functional structure illustrated in FIG. 11 is only one example. If the operation according to the embodiments of the present invention can be performed, any functional categories and any functional unit names may be used. The transmitting unit 110 and the receiving unit 120 may be referred to as a “communication unit.”

The transmitting unit 110 includes a function for generating signals to be transmitted to the terminal 20 side and transmitting the signals wirelessly. The receiving unit 120 includes a function of receiving various signals transmitted from the terminal 20 and acquiring, for example, higher layer information from the received signals. Also, the transmitting unit 110 has a function to transmit NR-PSS, NR-SSS, NR-PBCH, DL/UL control signals, DL data, and so forth, to the terminal 20. Furthermore, the transmitting unit 110 transmits the configuration information described in the embodiments and the like.

The configuration unit 130 stores configuration information that is configured in advance and various configuration information to be transmitted to the terminal 20, in a storage device, and reads the information from the storage device on an as-needed basis. The control unit 140 controls the entirety of the base station 10, including control related to signal transmission/reception. Note that a functional unit relating to signal transmission in the control unit 140 may be included in the transmitting unit 110, and a functional unit relating to signal reception in the control unit 140 may be included in the receiving unit 120. The transmitting unit 110 and the receiving unit 120 may be referred to as a “transmitter” and a “receiver,” respectively.

### <Terminal 20>

FIG. 12 is a diagram that illustrates an example functional structure of the terminal 20. As illustrated in FIG. 12, the terminal 20 includes a transmitting 210, a unit a receiving unit 220, configuration unit 230, and a control unit 240. The functional structure illustrated in FIG. 12 is only one example. Insofar as the operations according to the embodiments of the present invention can be performed, any functional categories and functional unit names may be used. The transmitting unit 210 and the receiving unit 220 may be referred to as a “communication unit.”

The transmitting unit 210 creates transmitting signals from the transmission data and transmits the transmitting signals wirelessly. The receiving unit 220 receives various signals wirelessly, and acquires signals of higher layers from the physical layer signals received. The transmitting unit 210 transmits HARQ-ACK, and the receiving unit 220 receives the configuration information described in the embodiments.

The configuration unit 230 stores various configuration received from the base station 10 by the receiving unit 220 in the storage device, and reads the stored configuration information from the storage device on an as-needed basis. The configuration unit 230 also stores the configuration information that is configured in advance. The control unit 240 controls the entire terminal 20, including control related to signal transmission and reception. Note that a functional unit relating to signal transmission in the control unit 240 may be included in the transmitting unit 210, and a functional unit relating to signal reception in the control unit 240 may be included in the receiving unit 220. Also, the transmitting unit 210 and the receiving unit 220 may be referred to as a “transmitter” and a “receiver,” respectively.

Any of the following terminals and base station may serve as the terminal or the base station of the herein-contained embodiments. Also, the following communication method may be executed.

### <Structures According to Embodiments>

### (Pattern 1)

A terminal including:
a receiving unit configured to receive a reference signal on a downlink; and
a transmitting unit configured to transmit a result of measurement based on the reference signal on an uplink, and
the receiving unit is further configured to receive information indicating antenna ports of a base station that are supported by the reference signal.

### (Pattern 2)

The terminal according to pattern 1,
in which the reference signal is a channel state information reference signal, and
in which the terminal further comprises a control unit configured to use the information indicating antenna ports in at least one of: periodic channel state information reporting; semi-persistent channel state information reporting; or aperiodic channel state information reporting.

### (Pattern 3)

The terminal according to pattern 2,
in which the receiving unit is further configured to receive information indicating a periodic CSI reporting group, including the information indicating antenna ports that are supported by the reference signal, and
in which the control unit is further configured to perform the periodic channel state information reporting, on the uplink, based on the information indicating antenna ports included in the information indicating the periodic CSI reporting group.

### (Pattern 4)

A base station including:
a transmitting unit configured to transmit reference signal to a terminal; and
a receiving unit configured to receive, from the terminal, a result of measurement based on the reference signal, and
the transmitting unit is further configured to transmit information indicating antenna ports of the base station that are supported by the reference signal.

### (Pattern 5)

A communication method executed by a terminal, the method including:
receiving a reference signal on a downlink;
transmitting a result of measurement based on the reference signal on an uplink; and
receiving information indicating antenna ports of a base station that are supported by the reference signal.

Any one of the above structures provides a technique that can save the power consumption of a base station. According to the second pattern, it is possible to limit a base station's ports in channel state information reporting. According to the third pattern, it is possible to limit a base station's ports based on information that indicates a periodic channel state information reporting group.

### (Hardware Structure)

The block diagrams (FIG. 11 and FIG. 12) used in the description of the above embodiments illustrate blocks of functional units. These functional blocks (components) are implemented by any combination of hardware and/or software. In addition, the method of implementing each functional block is not particularly limited. That is, each functional block may be implemented by using a single device that is physically or logically combined, or two or more devices that are physically or logically separated may be directly or indirectly connected (for example, by using a cable, radio, etc.), and each functional block may be implemented using these multiple devices. The functional blocks may be implemented by combining software with the device or devices.

The functions include, but are not limited to, judgment, determination, decision, calculation, computation, processing, derivation, research, search, verification, reception, transmission, output, access, resolution, selection, choosing, establishment, comparison, assumption, assumption, deeming, broadcasting, notifying, communicating, forwarding, configuring, reconfiguring, allocating, mapping, and assigning. For example, a functional block (component) that performs a transmission function is referred to as a “transmitting unit” or a “transmitter.” In either case, as described above, the method of implementation is not particularly limited.

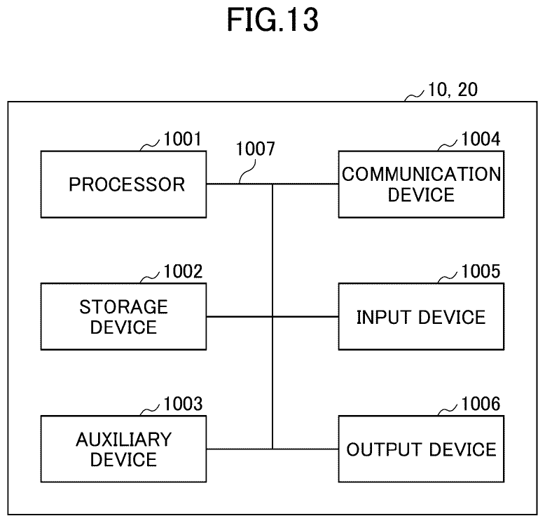

For example, the base station 10, the terminal 20, and so forth according to the embodiments of the present disclosure may function as a computer for processing the wireless communication method of the present disclosure. FIG. 13 is a diagram that illustrates an example hardware structure of the base station 10 and the terminal 20 according to an embodiment of the present disclosure. The base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following description, the term “device” can be read as circuit, apparatus, unit, and so forth. The hardware structure of the base station 10 and the terminal 20 may be configured to include one or more of the devices illustrated in the drawings, or may be configured without some of the devices.

The functions of the base station 10 and the terminal 20 are realized by performing operations by the processor 1001 by reading predetermined software (programs) on hardware such as the processor 1001 and the storage device 1002, and controlling communication by the communication device 1004 and controlling at least one of reading and writing of data in the storage device 1002 and the auxiliary storage device 1003.

The processor 1001 operates, for example, an operating system to control the entire computer. The processor 1001 may be composed of a central processing unit (CPU) including an interface with peripheral devices, a control device, an arithmetic device, a register, and the like. For example, the above-described control unit 140, control unit 240, and the like may be implemented by the processor 1001.

The processor 1001 reads out programs (program codes), software modules, data, or the like from at least one of the auxiliary storage device 1003 and the communication device 1004 to the storage device 1002, and performs various processes in accordance with the above. As for the programs, programs that cause the computer to execute at least part of the operations described in the above embodiments may be used. For example, the control unit 140 of the base station 10 illustrated in FIG. 11 may be stored in the storage device 1002 and implemented by control programs that operate on the processor 1001. For example, the control unit 240 of the terminal 20 illustrated in FIG. 12 may be stored in the storage device 1002 and implemented by control programs that operate on the processor 1001. Although the foregoing processes have been described and executed by one processor 1001, they may be executed simultaneously or sequentially by two or more processors 1001. The processor 1001 may be implemented by one or more chips. The programs may be transmitted from the network via a telecommunication line.

The storage device 1002 is a computer-readable recording medium and may be composed of at least one of, for example, a read-only memory (ROM), an erasable programmable ROM (EPROM), an electrically erasable programmable ROM (EEPROM), a random access memory (RAM), and the like. The storage device 1002 may be referred to as a register, cache, main memory (main storage device), or the like. The storage device 1002 can store programs (program codes), software modules, and so forth, executable to implement the communication method according to the embodiments of the present disclosure.

The auxiliary storage device 1003 is a computer-readable recording medium and may be composed of at least one of an optical disk, such as a compact disc ROM (CD-ROM), a hard disk drive, a flexible disk, a magneto-optical disk (for example, a compact disc, a digital versatile disc, a Blu-ray disc (registered trademark), etc.), a smart card, a flash memory (for example, a card, a stick, a key drive), a floppy disk (registered trademark), a magnetic strip, and the like. The storage medium described above may be, for example, a database, a server, or other suitable medium that includes at least one of a storage device 1002 and an auxiliary storage device 1003.

The communication device 1004 is hardware (a transceiving device) for performing communication between computers via at least one of a wired network and a wireless network, and is also referred to as a “network device,” a “network controller,” a “network card,” a “communication module,” or the like. The communication device 1004 may be composed of a high frequency switch, a duplexer, a filter, a frequency synthesizer, or the like, for example, to implement at least one of frequency division duplex (FDD) and time division duplex (TDD). For example, the transmitting/receiving antenna, the amplifier unit, the transceiving unit, the transmission line interface, and the like may be implemented by the communication device 1004. The transceiving unit may be physically or logically isolated, respective implementations of a transmitting unit and a receiving unit.

The input device 1005 is an input device (for example, a keyboard, a mouse, a microphone, a switch, a button, a sensor, etc.) that accepts external input. The output device 1006 is an output device (for example, a display, a speaker, an LED lamp, etc.) that implements external output. The input device 1005 and the output device 1006 may have an integral structure (for example, a touch panel).

Each device, such as the processor 1001 and the storage device 1002, is connected by a bus 1007 for communicating information. The bus 1007 may be constructed using a single bus or may be constructed using different buses between devices.

The base station 10 and the terminal 20 may also include hardware such as a microprocessor, a digital signal processor (DSP), an application-specific integrated circuit (ASIC), a programmable logic device (PLD), a field programmable gate array (FPGA), and so forth, and some or all of the functional blocks may be implemented by the hardware. For example, the processor 1001 may be implemented by using at least one of these hardware components.

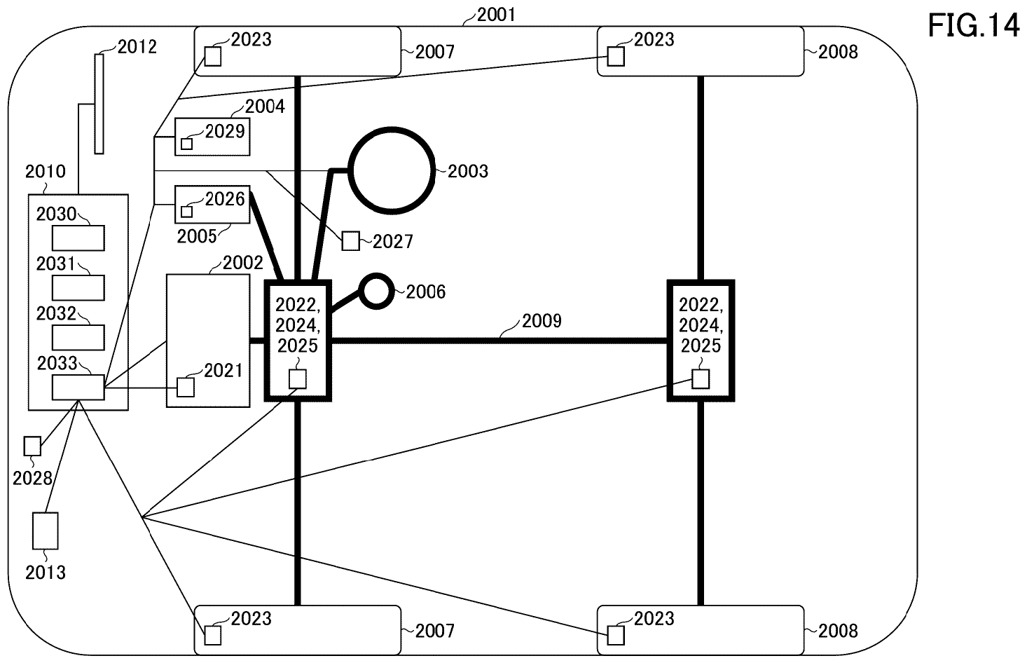

FIG. 11 shows an example structure of a vehicle 2001. As shown in FIG. 14, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013. The embodiments and examples described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the sensors 2021 to 2029 provided in the vehicle 2001. The electronic control unit 2010 may be referred to as an “electronic control unit” (ECU).

The signals from the sensors 2021 to 2029 include a current signal from a current sensor 2021 that senses the current of the motor, a front or rear wheel rotation speed signal acquired by a rotation speed sensor 2022, a front or rear wheel air pressure signal acquired by an air pressure sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, a shift lever operation signal acquired by a shift lever sensor 2027, and a detection signal, acquired by an object detection sensor 2028, for detecting an obstacle, a vehicle, a pedestrian, and the like.

The information service unit 2012 includes various devices for providing various information such as driving information, traffic information, and entertainment information, including a car navigation system, an audio system, a speaker, a television, and a radio, and one or more ECUs that control these devices. The information service unit 2012 provides various multimedia information and multimedia services to the occupants of the vehicle 2001 by using information obtained from external devices through the communication module 2013 or the like.

A driver assistance system unit 2030 includes: various devices for providing functions of preventing accidents and reducing the driver's burden of driving, such as a millimeter wave radar, a light detection and ranging (LiDAR) system, a camera, a positioning locator (for example, GNSS), map information (for example, high definition (HD) map, autonomous vehicle (AV) map, etc.), a gyro system (for example, an inertial measurement unit (IMU), an inertial navigation system (INS), etc.), an artificial intelligence (AI) chip, and an AI processor; and one or more ECUs that control these devices. In addition, the driver assistance system unit 2030 transmits and receives various information via the communication module 2013 to implement a driver assistance function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031, the memory (ROM, RAM) 2032 in the electronic control unit 2010, and the sensors 2021 to 29 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through wireless communication. The communication module 2013 may be internal or external to the electronic control unit 2010. The external devices may include, for example, a base station, a mobile station, or the like.

The communication module 2013 transmits a current signal, which is input to the electronic control unit 2010 from the current sensor, to the external devices through wireless communication. In addition, the communication module 2013 also transmits, to the external devices, through wireless communication, the front or rear wheel rotation speed signal acquired by the rotation speed sensor 2022, the front or rear wheel air pressure signal acquired by the air pressure sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped-on brake pedal signal acquired by the brake pedal sensor 2026, the shift lever operation signal acquired by the shift lever sensor 2027, and the detection signal, acquired by the object detection sensor 2028, for detecting an obstacle, a vehicle, a pedestrian, and the like, that are input to the electronic control unit 2010.

The communication module 2013 receives various information (traffic information, signal information, inter-vehicle information, etc.) transmitted from the external devices and displays the received information on the information service unit 2012 provided in the vehicle 2001. In addition, the communication module 2013 stores the information received from the external devices in the memory 2032, to which the microprocessor 2031 has access. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2029, and so forth, mounted in the vehicle 2001.

### (Notes on Embodiments)

Example embodiments of the present invention have been described above, but the disclosed invention is not limited to the above embodiments, and those skilled in the art would understand that there may be various modified examples, revised examples, alternative examples, substitution examples, and the like. In order to facilitate understanding of the invention, specific numerical values have been used for description, but the numerical values are merely examples, and any suitable values may be used unless otherwise specified. The classification of items in the above description is not essential to the present invention. Matters described as two or more items may be combined if necessary, and a matter described as one item may be applied to another item (as long as there is no contradiction). The boundary between functional units or processing units in a functional block diagram does not necessarily correspond to the boundary between physical parts. Operations of multiple functional units may be performed physically by one component, or an operation of one functional unit may be physically performed by multiple parts. In the processing procedures described in the embodiments, the order of the processes may be changed as long as there is no contradiction. For the sake of convenience of processing description, the base station 10 and the terminal 20 are described using functional block diagrams, but such devices may be implemented by hardware, software, or a combination of these. Software executed by the processor included in the base station 10 according to the embodiments of the present invention and software executed by the processor included in the terminal 20 according to the embodiments of the present invention may be stored in a random access memory (RAM), a flash memory, a read-only memory (ROM), an EPROM, an EEPROM, a register, a hard disk drive (HDD), a removable disk, a CD-ROM, a database, a server, or any other appropriate storage medium.

Furthermore, notification of information is not limited to the embodiments or examples described in the present disclosure, and may be provided by using any other method. For example, the notification of information may be provided by physical layer signaling (for example, downlink control information (DCI) or uplink control information (UCI)), higher layer signaling (for example, radio resource control (RRC) signaling, medium access control (MAC) signaling, broadcast information (master information block (MIB), system information block (SIB), etc.), other signals, or a combination thereof. Furthermore, RRC signaling may be referred to as an “RRC message” and may be, for example, an RRC connection setup message, an RRC connection reconfiguration message, or the like.

Each embodiment and example described in the present disclosure may be applied to at least one of long-term evolution (LTE), LTE-advanced (LTE-A), SUPER 3G, IMT-Advanced, 4th generation mobile communication system (4G), 5th generation mobile communication system (5G), 6th generation mobile communication system (6G), x-th generation mobile communication system (xG) (where “x” is an integer, decimal, etc.), future radio access (FRA), new radio (NR), new radio access (NX), future generation radio access, W-CDMA (registered trademark), GSM (registered trademark), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and next generation systems enhanced, modified, created, and defined based on these standards. Furthermore, multiple systems (for example, a combination of at least one of LTE and LTE-A, with 5G) may be combined to be applied.

The order of the processing procedures, the order of the sequences, the order of the flowcharts, and the like of the respective embodiments and examples described in this specification may be changed, provided that there is no contradiction. For example, the method described in the present disclosure presents elements of various steps with an example order and is not limited to the presented, specific order.

In this specification, a specific operation to be performed by the base station 10 may be performed by its upper node in some cases. In a network including one or more network nodes including the base station 10, various operations performed for communication with the terminal 20 can be obviously performed by at least one of the base station 10 and any network node (for example, an MME, an S-GW, and so forth, but these are by no means limiting) other than the base station 10. Cases have been shown above in which there is one network node other than the base station 10. The one network node may be a combination of multiple other network nodes (for example, MME and S-GW).

Information, a signal, or the like described in the present disclosure may be output from a higher layer to a lower layer (or from a lower layer to a higher layer). Information, a signal, or the like described in the present disclosure may be input and output via multiple network nodes.

Input and output information and the like may be stored in a specific place (for example, a memory), or may be managed by using a management table. Input and output information and the like may be overwritten, updated, or additionally written. Output information and the like may be deleted. Input information and the like may be transmitted to other devices.

The determination in the present disclosure may be made in accordance with a value (0 or 1) represented by one bit, may be made in accordance with a Boolean value (Boolean: true or false), or may be made by a comparison of numerical values (for example, a comparison with a predetermined value).

Software should be broadly interpreted to mean a command, a command set, a code, a code segment, a program code, a program, a subprogram, a software module, an application, a software application, a software package, a routine, a subroutine, an object, an executable file, an execution thread, a procedure, a function, and the like, regardless of whether software is called “software,” “firmware,” “middleware,” a “microcode,” a “hardware description language,” or any other name.

Furthermore, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL)) and a radio technology (such as infrared rays or a microwave), at least one of these wired technology and radio technology is included in a definition of a transmission medium.

Information, signals, and the like described in the present disclosure may be expressed using any one of a variety of techniques. For example, data, instructions, commands, signals, bits, symbols, chips, and the like, which are mentioned throughout the above description, may be expressed by voltages, currents, electromagnetic waves, magnetic fields or magnetic particles, optical fields or photons, or any combination thereof.

The terms described in the present disclosure and the terms necessary for understanding the present disclosure may be replaced with terms having the same or similar meanings. For example, at least one of a channel and a symbol may be a signal (signaling). Furthermore, a signal may be a message. Furthermore, a component carrier (CC) may be referred to as a “carrier frequency,” a “cell,” a “frequency carrier,” or the like.

The terms “system” and “network” used in the present disclosure are interchangeable.

Furthermore, the information, parameters, and the like described in the present disclosure may be expressed by using absolute values, may be expressed by using relative values from predetermined values, or may be expressed by using any other corresponding information. For example, radio resources may be indicated by indices.

The names used for the above-described parameters are not limited names in any point of view. Furthermore, mathematical formulas or the like using the parameters may be different from those explicitly disclosed in the present disclosure. Since various channels (for example, PUCCH, PDCCH, etc.) and information elements can be identified by any suitable names, various names assigned to the various channels and the information elements are not limited names in any point of view.

In the present disclosure, the terms “base station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to by a term such as a “macrocell,” a “small cell,” a “femtocell,” and a “picocell.”

The base station can accommodate one or more (for example, three) cells. In a case in which the base station accommodates multiple cells, the entire coverage area of the base station can be partitioned into a plurality of small areas, and each small area can provide a communication service through a base station subsystem (for example, a small indoor base station (RRH: Remote Radio Head)). The term “cell” or “sector” refers to the whole or a part of the coverage area of at least one of the base station and the base station subsystem that performs a communication service in the coverage.

In the present disclosure, the terms “mobile station (MS),” “user terminal,” “user equipment (UE),” “terminal,” and the like can be used interchangeably.

The mobile station may be referred to, by a person ordinarily skilled in the art, as a “subscriber station,” a “mobile unit,” a “subscriber unit,” a “wireless unit,” a “remote unit,” a “mobile device,” a “wireless device,” a “wireless communication device,” a “remote device,” a “mobile subscriber station,” an “access terminal,” a “mobile terminal,” a “wireless terminal,” a “remote terminal,” a “handset,” a “user agent,” a “mobile client,” a “client,” or some other suitable terms.

At least one of the base station and the mobile station may be also referred to as a “transmission device,” a “receiving device,” a “communication device,” or the like. At least one of the base station and the mobile station may be a device installed in a mobile body, a mobile body itself, or the like. The mobile body may be a vehicle (for example, a car, an airplane, etc.), an unmanned body that moves (for example, a drone, an autonomous car or the like), or a robot (manned type or unmanned type). At least one of the base station and the mobile station includes a device that need not move during communication operation. For example, at least one of the base station and the mobile station may be an Internet of things (IoT) device such as a sensor.

Furthermore, the base station in the present disclosure may be replaced by the user terminal. For example, various embodiments and examples of the present disclosure may be applied to a configuration in which communication between the base station and the user terminal is replaced by communication between multiple terminals 20 (such communication may be referred to as “device-to-device (D2D)” communication, “vehicle-to-everything (V2X)” communication, etc.). In this case, the terminals 20 may have and perform the functions that the base station 10 described above has. The phrases “uplink” and “downlink” may also be replaced by phrases corresponding to terminal-to-terminal communication (for example, “side”). For example, an uplink channel, a downlink channel, or the like may be replaced by a side channel.

Similarly, the user terminal in the present disclosure may be replaced with the base station. In this case, the base station may have the functions of the above-described user terminal.

The terms “determination (determining)” and “decision (determining)” used in the present specification may include various types of operations. The “determination” and “decision” may include deeming “judging,” “calculating,” “computing,” “processing,” “deriving,” “investigating,” “looking up (for example, searching in a table, a database, or another data structure),” “searching,” “inquiring,” or “ascertaining” as “determining” and/or “deciding.” Furthermore, the “determination” and “decision” may include deeming “receiving (for example, receiving information),” “transmitting (for example, transmitting information),” “inputting,” “outputting,” or “accessing (for example, accessing data in a memory)” as “determining” and/or “deciding.” Furthermore, the “determination” and “decision” may include deeming “resolving,” “selecting,” “choosing,” “establishing,” or “comparing” as “determining” and/or “deciding.” Namely, the “determination” and “decision” may include deeming an operation as “determining” and/or “deciding.” Furthermore, “determining” may be replaced with “assuming,” “expecting,” “considering,” or the like.

The terms “connected,” “coupled,” or variations thereof may mean any direct or indirect connection or coupling between two or more elements and may include the presence of one or more intermediate elements between two elements which are “connected” or “coupled.” The coupling or the connection between the elements may be physical, logical, or a combination thereof. For example, “connection” may be replaced with “access.” In the present disclosure, two elements may be considered to be “connected” or “coupled” with each other using at least one of one or more electric wires, cables and/or a printed electrical connection or using electromagnetic energy having a wavelength in a radio frequency region, a microwave region, or a light (both visible and non-visible) region as non-limiting and non-exhaustive examples.

A reference signal may be abbreviated as “RS” and may be referred to as a “pilot,” depending on the standard that is applied.

The phrase “based on” used in the present disclosure does not only mean “based only on,” unless otherwise stated. In other words, the phrase “based on” means both “based only on” and “based at least on.”

Any reference to an element using a designation such as “first” or “second,” used in the present disclosure, does not generally restrict quantities or the order of those elements. Such designation can be used in the present disclosure as a convenient method of distinguishing between two or more elements. Thus, reference to the first and second elements does not mean that only two elements can be adopted there or that the first element must precede the second element in a certain way.

Furthermore, “means” in the structure of each of the above devices may be replaced with “unit,” “part,” “circuit,” “device,” or the like.

When “include,” “including,” and variations thereof are used in the present disclosure, these terms are intended to be comprehensive, similar to the term “provided with (comprising).” Furthermore, the term “or” used in the present disclosure is intended not to be an exclusive OR.

A radio frame may include one or more frames in the time domain. In the time domain, each of one or more frames may be referred to as a “subframe.” The subframe may further include one or more slots in the time domain. The subframe may have a fixed time length (for example, 1 ms) not depending on numerology.

Numerology may be a communication parameter applied to at least one of transmission and reception of a certain signal or channel. For example, numerology may indicate at least one of subcarrier spacing (SCS), the bandwidth, the symbol length, the cyclic prefix length, the transmission time interval (TTI), the number of symbols per TTI, the radio frame structure, a specific filtering process performed in the frequency domain by a transceiver, a specific windowing process performed in the time domain by a transceiver, and the like.

A slot may include one or more symbols (orthogonal frequency division multiplexing (OFDM) symbols, single carrier frequency division multiple access (SC-FDMA) symbols, etc.) in the time domain. A slot may be a time unit based on numerology.

A slot may include a plurality of mini slots. Each mini slot may include one or more symbols in the time domain. Furthermore, a mini slot may be referred to as a “sub-slot.” A mini slot may include fewer symbols than a slot. PDSCH (or PUSCH) that is transmitted in a unit of time greater than a mini slot may be referred to as “PDSCH (or PUSCH) mapping type A.” PDSCH (or PUSCH) that is transmitted using a mini slot may be referred to as “PDSCH (or PUSCH) mapping type B.”

Any one of a radio frame, a subframe, a slot, a mini slot, and a symbol indicates a time unit for transmitting a signal. As a radio frame, a subframe, a slot, a mini slot, and a symbol, different names corresponding to them may be used.

For example, one subframe may be referred to as a “transmission time interval (TTI),” or a plurality of consecutive subframes may be referred to as a “TTI,” or one slot or one mini slot may be referred to as a “TTI.” In other words, at least one of the subframe and the TTI may be a subframe (1 ms) in conventional LTE, may be a period shorter than 1 ms (for example, 1 to 13 symbols), or may be a period longer than 1 ms. A unit representing the TTI may be referred to as a “slot,” a “mini slot,” or the like, instead of “subframe.”

Here, for example, the TTI refers to a minimum time unit of scheduling in wireless communication. For example, in an LTE system, the base station performs scheduling of allocating radio resources (frequency bandwidth, transmission power, or the like which can be used in each terminal 20) to each terminal 20 in units of TTIs. The definition of the TTI is not limited thereto.

The TTI may be a transmission time unit such as a channel-coded data packet (transport block), a code block, or a codeword, or may be a processing unit of, for example, scheduling or link adaptation. Furthermore, when a TTI is provided, the time interval (for example, the number of symbols) in which a transport block, a code block, a codeword, or the like is actually mapped may be shorter than the TTI.

When one slot or one mini slot is referred to as a “TTI,” one or more TTIs (that is, one or more slots or one or more mini slots) may be a minimum time unit of scheduling. Furthermore, the number of slots (the number of mini slots) forming the minimum time unit of scheduling may be controlled.

A TTI having a time length of 1 ms may be referred to as a “common TTI” (TTI in LTE Rel. 8 to 12), a “normal TTI,” a “long TTI,” a “common subframe,” a “normal subframe,” a “long subframe,” a “slot,” or the like. A TTI shorter than a common TTI may be referred to as a “reduced TTI,” a “short TTI,” a “partial TTI” (a partial or fractional TTI), a “reduced subframe,” a “short subframe,” a “mini slot,” a “sub slot,” a “slot,” or the like.

Furthermore, a long TTI (for example, a normal TTI, a subframe, etc.) may be replaced with a TTI having a time length exceeding 1 ms, and a short TTI (for example, a reduced TTI or the like) may be replaced with a TTI having a TTI length that is shorter than a TTI length of a long TTI and that is longer than or equal to 1 ms.

The resource block (RB) is a resource allocation unit in the time domain and the frequency domain, and may include one or more consecutive subcarriers in the frequency domain. The number of subcarriers included in an RB may be the same, irrespective of the numerology and may be, for example, 12. The number of subcarriers included in an RB may be determined based on numerology.

Furthermore, the time range of an RB may include one or more symbols and may have a length of one slot, one mini slot, one subframe, or one TTI. One TTI, one subframe, or the like may be formed with one or more resource blocks.

Furthermore, one or more RBs may be referred to as a “physical resource block (PRB),” a “subcarrier group (SCG),” a “resource element group (REG),” a “PRB pair,” an “RB pair,” or the like.

Furthermore, a resource block may be formed with one or more resource elements (REs). For example, one RE may be a radio resource field of one subcarrier and one symbol.

A bandwidth part (BWP) (which may be referred to as a “partial bandwidth” or the like) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include BWP for UL (UL BWP) and BWP for DL (DL BWP). In the terminal 20, one or more BWPs may be configured in one carrier.

At least one of configured BWPs may be active, and the terminal 20 need not assume that predetermined signals/channels are transmitted and received outside an active BWP. Furthermore, a “cell,” a “carrier,” or the like in the present disclosure may be replaced with a “BWP.”

Structures of the radio frame, the subframe, the slot, the mini slot, and the symbol are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the cyclic prefix (CP) length, and the like can be variously changed.

In the present disclosure, for example, when an article such as “a,” “an,” or “the” in English is added by a translation, the present disclosure may include a case in which a noun following the article is the plural.

In the present disclosure, “A and B are different” may mean “A and B are different from each other.” However, this may also mean “A and B are different from C.” Terms such as “separated” or “combined” may be interpreted as well as “different.”

Each embodiment or example described in the present disclosure may be used alone, in combination, or may be switched in accordance with the implementation. Furthermore, notification of predetermined information (for example, notification of “being X”) is not limited to notification performed explicitly, but may be performed implicitly (for example, not notifying the predetermined information).

Although the present disclosure has been described above in detail, it is obvious to those skilled in the art that the present disclosure is not limited to the embodiments described in the present disclosure. The present disclosure may be implemented as revised and modified embodiments without departing from the gist and scope of the present disclosure as set forth in the accompanying claims. Accordingly, the description of the present disclosure is for the purpose of illustration and does not have any restrictive meaning to the present disclosure.

### DESCRIPTION OF THE REFERENCE NUMERALS

10 base station
110 transmitting unit
120 receiving unit
130 configuration unit
140 control unit
20 terminal
210 transmitting unit
220 receiving unit
230 configuration unit
240 control unit
1001 processor
1002 storage device
1003 auxiliary storage device
1004 communication device
1005 input device
1006 output device
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 rotation speed sensor
2023 air pressure sensor
2024 vehicle speed sensor
2025 acceleration sensor
2026 brake pedal sensor
2027 shift lever sensor
2028 object detection sensor
2029 accelerator pedal sensor
2030 driver assistance system unit
2031 microprocessor
2032 memory (ROM, RAM)
2033 communication port (IO port)

1. A terminal comprising:
a receiving unit configured to receive a reference signal on a downlink; and
a transmitting unit configured to transmit a result of measurement based on the reference signal on an uplink,
wherein the receiving unit is further configured to receive information indicating antenna ports of a base station that are supported by the reference signal.

2. The terminal according to claim 1,
wherein the reference signal is a channel state information reference signal, and
wherein the terminal further comprises a control unit configured to use the information indicating antenna ports in at least one of: periodic channel state information reporting; semi-persistent channel state information reporting; or aperiodic channel state information reporting.

3. The terminal according to claim 2,
wherein the receiving unit is further configured to receive information indicating a periodic CSI reporting group, including the information indicating antenna ports that are supported by the reference signal, and
wherein the control unit is further configured to perform the periodic channel state information reporting, on the uplink, based on the information indicating antenna ports included in the information indicating the periodic CSI reporting group.

4. A base station comprising:
a transmitting unit configured to transmit a reference signal to a terminal; and
a receiving unit configured to receive, from the terminal, a result of measurement based on the reference signal,
wherein the transmitting is further unit configured to transmit information indicating antenna ports of the base station that are supported by the reference signal.

5. A communication method executed by a terminal, the method comprising:
receiving a reference signal on a downlink;
transmitting a result of measurement based on the reference signal on an uplink; and
receiving information indicating antenna ports of a base station that are supported by the reference signal.
